(19) United States
(12) Patent Application Publication
(10) Pub. No.: US 2009/0030867 A1
(43) Pub. Date: Jan. 29, 2009

(54) REVIEWING APPARATUS, RECIPE SETTING METHOD FOR REVIEWING APPARATUS AND REVIEWING SYSTEM

(75) Inventors: Takehiro HIRAI, Ushiku (JP); Kenji Obara, Kawasaki (JP); Masashi Sakamoto, Hitachinaka (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 12/178,976

(22) Filed: Jul. 24, 2008

(30) Foreign Application Priority Data
Jul. 25, 2007 (JP) 2007-193479

(51) Int. Cl. G06N 5/02; G06F 17/30

(52) U.S. Cl. 706/50

(57) ABSTRACT

A recipe setting method and reviewing apparatus which permit even a novice to analyze the contents of existing recipe settings without trial-and-error attempts in the reviewing apparatus for reviewing a sample and to create a new recipe in a short time based on the results of the analysis. By a reviewing apparatus having a function of reviewing a sample under registered review conditions, based on a recipe in which the review conditions are registered. The reviewing apparatus is configured to display a list of the contents of the settings of plural set items regarding plural recipes and to create a new recipe based on the results of analysis of commonality by using the contents of settings having high degrees of commonality as initial settings.

### BACKGROUND OF THE INVENTION

The present invention relates to a reviewing apparatus for reviewing samples under various review conditions, based on recipes in which the review conditions are registered. Especially, the invention relates to an apparatus that needs to optimize optical conditions because optimal optical conditions are different according to the characteristics of samples such as a SEM (scanning electron microscope)-based defect reviewing apparatus or SEM-based defect review tool. Furthermore, the invention relates to a reviewing apparatus that needs to optimize conditions for achieving both high capture rate and high throughput such as an automatic defect review (ADR) tool.

In semiconductor fabrication, it is important that defects produced during fabrication processes be discovered at early stages and countermeasures against them be taken, in order to secure high production yield. In recent years, as semiconductor devices have diminished in size, effects of even quite small defects on the yield can no longer be neglected. Defects to be reviewed have become more versatile.

A SEM-based defect reviewing apparatus is a tool for reviewing such various defects. Generally, this reviewing apparatus is used to review defects, based on defect locations detected by a host inspection tool. Where a manual review is performed, the sample stage is moved into coordinates outputted by the host inspection tool. Then, the sample is imaged at a low magnification at which the sample comes within the field of view. The position of the defect is checked visually. Then, the sample stage is moved such that the position of the defect comes to the center of the field of view. An image of the defect for review is acquired at high magnification. Automation of this sequence of process steps is ADR.

In ADR, various conditions including optical conditions corresponding to a sample, ADR mode, conditions under which low-magnification images are acquired, and conditions under which high-magnification images are acquired need to be optimized to achieve both high capture rate and high throughput. Because the number of combinations of items to be set is exorbitant, the ADR is a work which is difficult to optimize even for experienced skilled persons and which needs trial-and-error attempts. Therefore, there is a need for facilitation of the work for optimizing the contents of the settings.

A recipe setting method implemented in a defect inspection tool and consisting of setting a plurality of inspection conditions, effecting inspections under each condition, and adopting a condition under which the most defects can be detected as a final recipe setting is disclosed in patent reference 1 (JP-A-2005-017159).

A method of enabling recipe parameters setting forth fabrication processes in semiconductor fabrication equipment to be edited in a batch is disclosed in patent reference 2 (JP-A-05-283308).

### SUMMARY OF THE INVENTION

Although the method disclosed in the above-cited patent reference 1 makes it possible to efficiently make trial-and-error attempts for recipe condition optimization, trial-and-error attempts are still made under varied conditions. Therefore, there is the problem that the processing time is long. When the conditions are varied, it is difficult for a novice to precisely judge how the conditions should be varied. Furthermore, in the case of a SEM-based defect-reviewing apparatus, the same sample is reviewed repeatedly, creating the possibility that damages to the sample are accumulated. Consequently, it is desired to avoid acquiring images repeatedly while varying review conditions.

The method disclosed in the above-cited patent reference 2 enables recipe parameters used in semiconductor fabrication equipment to be edited in a batch. This is effective in improving the efficiency of the intended editing work and reducing setting errors. However, there is no mention of any detailed method of analysis permitting one to judge as to how the set conditions should be varied to produce optimum results. In addition, when a new recipe is created, there is no mention of any detailed method of effectively exploiting the results of analysis of existing recipes.

It is a main object of the present invention to provide recipe analysis method, recipe setting method, and reviewing apparatus which permit even a novice to analyze the contents of existing recipe settings without trial-and-error attempts in the reviewing apparatus and to create a new recipe in a short time based on the result of the analysis.

To achieve the above-described object, an embodiment of the present invention provides a reviewing apparatus having a function of reviewing a sample under registered review conditions, based on a recipe in which the review conditions are registered. A main feature is to enable the contents of settings of plural set items for plural recipes to be displayed in the form of a list. Another main feature is to create a new recipe based on the results of analysis of common features, using the contents of settings having high degrees of commonality as initial settings.

According to the present invention, even a novice can analyze the contents of existing recipe settings. Especially, he can easily judge the commonality. Therefore, it is only required to examine the contents of settings regarding only items having low degrees of commonality. Hence, a novel recipe can be created in a short time. Furthermore, the throughput of the created recipe can be forecasted. Therefore, the validity of the set items can be confirmed. Where the contents of the settings are modified, the recipe settings can be optimized while checking the effects of the modification.

### BRIEF DESCRIPTION OF THE DRAWINGS

FIG. 1 is a cross-sectional view showing the fundamental structure of a SEM-based semiconductor defect-reviewing apparatus.

FIG. 2 is a table showing one example of a shown list of the results of a recipe analysis.

FIG. 3 is a diagram showing one example of GUI (graphical user interface) for setting items subjected to a recipe analysis.

FIGS. 4A and 4B are diagrams showing one example of GUI for implementing a recipe analysis.

FIG. 5 is a diagram showing one example in which calculated throughput values and actually measured values are added to shown results of a recipe analysis.

FIG. 6 is a diagram showing one example of GUI in which the results of a recipe analysis and an acquired image are made to correspond to each other and displayed.

FIGS. 7A-7C are diagrams showing examples of a reviewing system in which plural reviewing apparatus holding recipes are connected via a network.

### DETAILED DESCRIPTION OF THE EMBODIMENTS

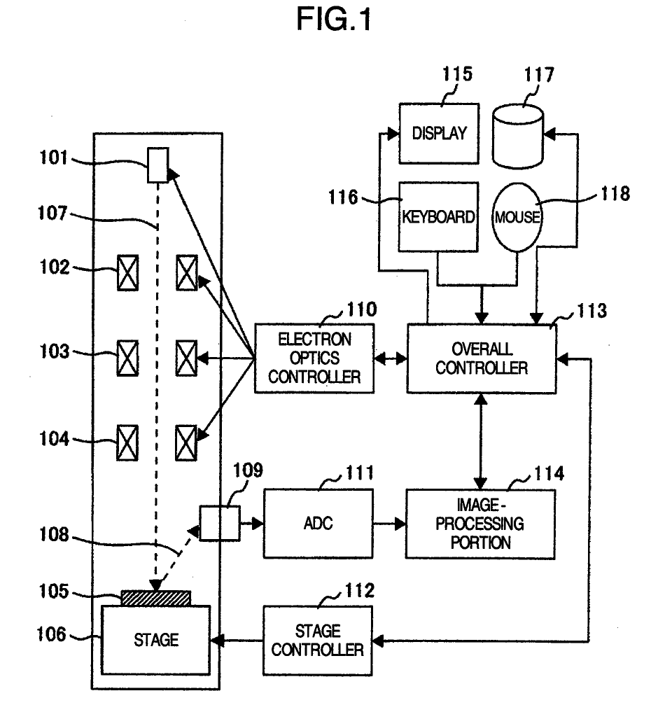

Embodiments of the present invention are described. FIG. 1 is a cross-sectional view showing the configuration of a SEM-based defect-reviewing apparatus that is one embodiment of the present invention. The SEM-based defect-reviewing apparatus shown in FIG. 1 is used to review a sample 105 and composed of an electron gun 101, a lens 102, a deflector 103, an objective lens 104, a stage 106, a secondary particle detector 109, an electron optics controller 110, an A/D converter (ADC) 111, a stage controller 112, an overall controller 113, an image-processing portion 114, a display device 115, a keyboard 116, a storage device 117, a computer mouse 118. An electron beam 107 emitted from the electron gun 101 is focused by the lens 102 and deflected by the deflector 103. Then, the beam is focused by the objective lens 104 and made to hit the sample 105. The sample 105 irradiated with the electron beam 107 produces secondary particles 108 such as secondary electrons and backscattered electrons according to the shape and material of the sample. The produced secondary particles 108 are detected by the secondary particle detector 109 and converted into a digital signal by the A/D converter 111. Thus, a SEM image is created. Image processing such as detection of defects is performed by the image-processing portion 114, using the created SEM image. The lens 102, deflector 103, and objective lens 104 are controlled by the electron optics controller 110. The position of the sample is controlled by the stage 106 that is under control of the stage controller 112. The overall controller 113 interprets inputs from the keyboard 116, mouse 118, and storage device 117 and controls various portions including the electron optics controller 110, stage controller 112, and image-processing portion 114. If necessary, the overall controller outputs the contents of processing to the display device 115 and storage device 117.

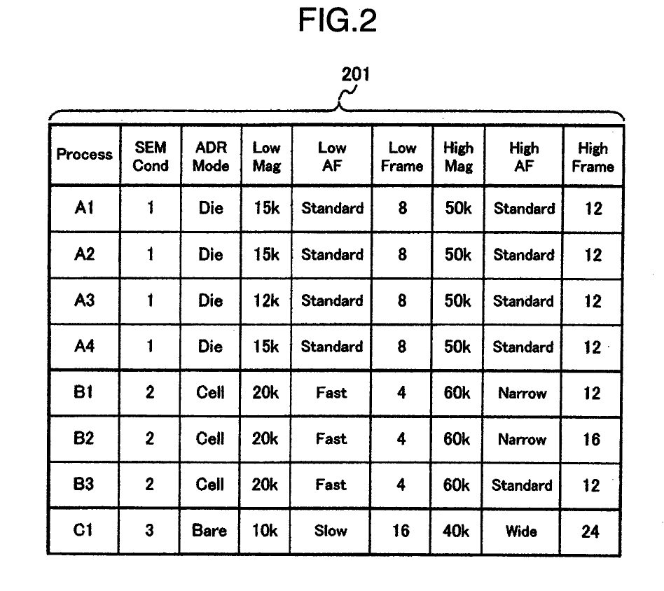

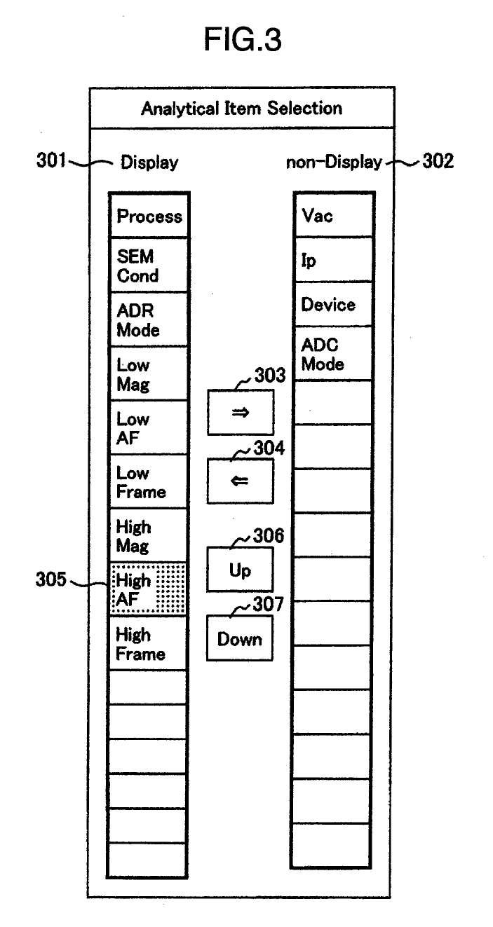

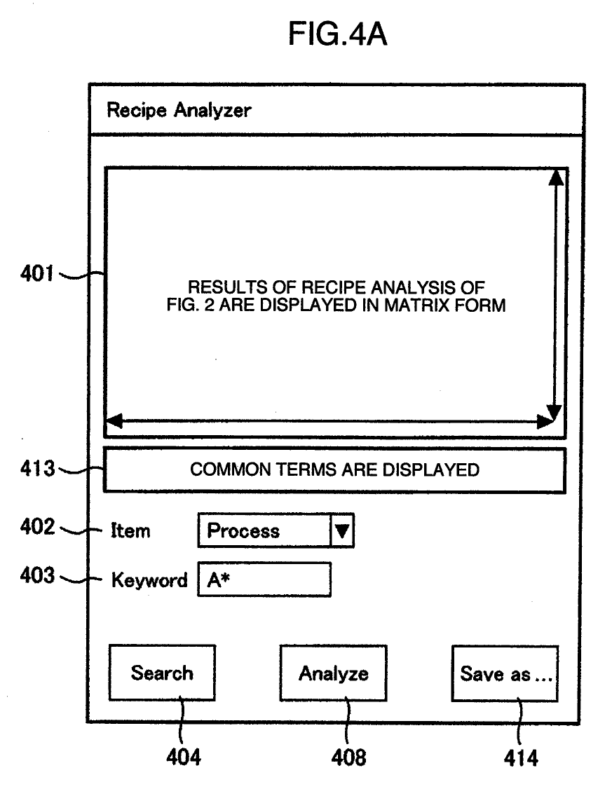

FIG. 2 shows one example of the results of a recipe analysis. In this example, contents of recipe settings are shown as items of a list 201. That is, the shown items are process name (Process), optical conditions (SEM Cond), ADR mode (ADR Mode), magnification of low-magnification images (Low Mag), autofocus conditions of low-magnification images (Low AF), the number of added frames of low-magnification images (Low Frame), magnification of high-magnification images (High Mag), autofocus conditions of high-magnification images (High AF), and the number of added frames of high-magnification images (High Frame). In FIG. 2, the optical conditions are indicated by numerals. For example, where the optical conditions are defined by combinations of plural conditions including accelerating voltage (Vac) and probe current (Ip), each condition may be treated as an independent analysis item. Furthermore, comment registered by the user, capture rate used when there is an ADR function, recipe creator, date of creation, recipe updater, date of updating, and recipe version can be registered as analysis items. In the ADR mode, the ADR algorithm is switched according to the sample. Three modes are shown in FIG. 2: (1) die comparison mode (Die) in which the throughput is low because it is necessary to acquire a reference image but it is possible to cope with any arbitrary background pattern; (2) cell comparison mode (Cell) in which the throughput is high because no reference image is required but the recipe can be used only when there is a background pattern having periodicity; and (3) bare mode (Bare) in which the recipe is effective only for samples having no background pattern.

As the magnification of a low-magnification image becomes higher, defects are detected more easily. However, the probability that defects do not come within the field of view is increased. Consequently, optimization must be done taking account of the tradeoff between the size of the defect to be detected and the coordinate accuracy. In a first set of autofocus conditions for low-magnification images, a standard algorithm is used (Standard). In a second set of autofocus conditions, the processing speed is high but the accuracy is lower than that provided by the standard algorithm (Fast). In a third set of autofocus conditions, the processing speed is low but the accuracy is higher than that provided by the standard algorithm (Slow). As the number of added frames of low-magnification images is increased, noise is reduced. Therefore, where emphasis is placed on the capture rate rather than the throughput, the number of added frames of low-magnification images is set to a large value. The magnification of high-magnification images is determined according to the size of the defect to be reviewed. The magnification of high-magnification images, autofocus conditions for high-magnification images, and the number of added frames are similar in meaning to the magnification of low-magnification images, autofocus conditions, and the number of added frames, respectively, but are used for final check of the defect image. Therefore, settings are often made while placing emphasis on the image quality rather than the throughput in comparison with low-magnification images. Contents of settings including device name and automatic device classification (ADC) (not shown in FIG. 2) are items to be analyzed.

FIG. 3 shows one example of GUI for selecting an item to be analyzed. Items registered in a display list 301 are displayed as results of an analysis as shown in FIG. 2. Items registered in a non-display list 302 are not displayed as results of an analysis. Movement from the list 301 to the list 302 is effected by depressing a right-arrow button 303. Movement from the list 302 to the list 301 is effected by depressing a left-arrow button 304. When an order of registration should be modified within each list, an item to be moved is selected as indicated by 305. Where the user wants to replace the selected item by an item located at the immediately above location, an Up button 306 is depressed. Where the user wants to replace the selected item by an item located at the immediately below location, a Down button 307 is depressed.

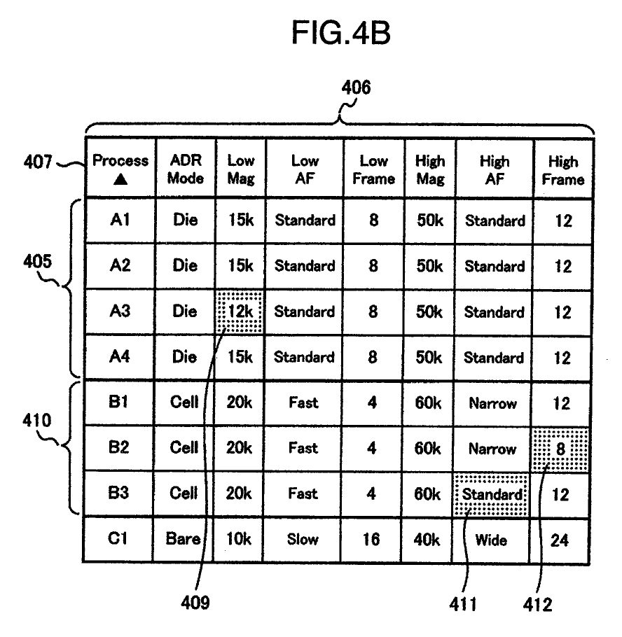

A procedure for analyzing the commonality among the set items is described taking the example of FIGS. 4A and 4B. A list of contents of recipe settings as shown in FIG. 4B is displayed in a list display area 401 of FIG. 4A. FIG. 4B is a part extracted from FIG. 2.

With respect to the commonality among the set items, when the items of various contents of settings set for individual recipes contain items (herein referred to as common items) common to different recipes and the number of the common items is large in number, it is determined that the level of commonality is high. On the other hand, when the common items are few in number, it is determined that the level of commonality is low.

First, “Item” 402 to be analyzed for its commonality is selected using a pointing device such as a computer mouse. In this example, “Process” is selected. After “Item” has been selected, a keyword is entered using the input device such as a keyboard. A Search button 404 is depressed. In the illustrated example, a character string starting with A is specified as the keyword. Therefore, a recipe 405 having a Process name starting with A is displayed in the list display area 401. In this example, recipes displayed in the list are restricted using a Search function. Where recipes are few in number, it is not always necessary to limit recipes displayed. Furthermore, the list can be sorted by the Item to be analyzed.

FIG. 4B shows the results of sorting executed based on “Process” 407. In this way, as the need arises, preparations are made to select a recipe to be analyzed by employing a sorting or Search function. Then, the recipe to be analyzed is selected. As an example, it is assumed that a recipe 405 having a “Process” name starting at A has been selected. After the selection, an Analyze button 408 is depressed to perform the analysis. An item (409) judged to have a low degree of commonality as a result of the analysis is highlighted. In the illustrated example, only those which have low degrees of commonality are highlighted, indicating their degrees of commonality. Alternatively, those having high degrees of commonality may be distinguished from others and highlighted. Still alternatively, plural different levels of range of frequencies of occurrence may be previously set. Frequencies of occurrence may be distinguished using the levels of range. It can be seen that in the example of 409, only the recipe having a “Process” name of A3 is set to a low value of “Low Mag”. If this setting is made higher in conformity with other process names A1, A2, and A4, the low-magnification image derived by detecting a defect is enlarged. Consequently, there is the possibility that defect-detecting performance, i.e., the capture rate, can be improved.

Similarly, analysis of common terms of recipes 410, each having a “Process” name starting with B, reveals that the degree of commonality between High AF (411) of B3 and “High Frame” (412) of B2 is low. The result of the analysis shows that if the autofocus settings of the high-magnification image of B3 are set to a high-speed mode in the same way as B1 and B2, the throughput may be improved, and that if the number of added frames of high-magnification images of B2 is set to the same value as that of B1 and B3, an image of higher quality will be acquired. This would result in favorable results.

Where the settings are modified, an element of the list that the user wants to change is selected using the pointing device such as a mouse, and then the settings can be varied using the input device such as a keyboard. Plural elements may be selected and the settings may be modified in a batch mode.

A procedure of creating a recipe is now described. In this procedure, the contents of settings having high degrees of commonality are taken as initial values, based on the results of an analysis. As an example, a recipe 410 having a “Process name” starting with B is a subject to be analyzed. When the Analyze button 408 is depressed and the analysis is started, items having high degrees of commonality are displayed in the common item display area 413. In the present example, “Process:B*”, “ADR Mode:Cell”, “Low Mag:20k”, “Low AF:Fast”, “Low Frame:4”, “High Mag:60k”, “High AF:Narrow”, “High Frame:12” are shown initially. Where the contents of the settings are updated according to the need and a recipe having a “Process” name of B4, for example, is newly created, the “Process” name of “B*” is updated to “B4”. The recipe can be easily created by depressing “Save as” button 414.

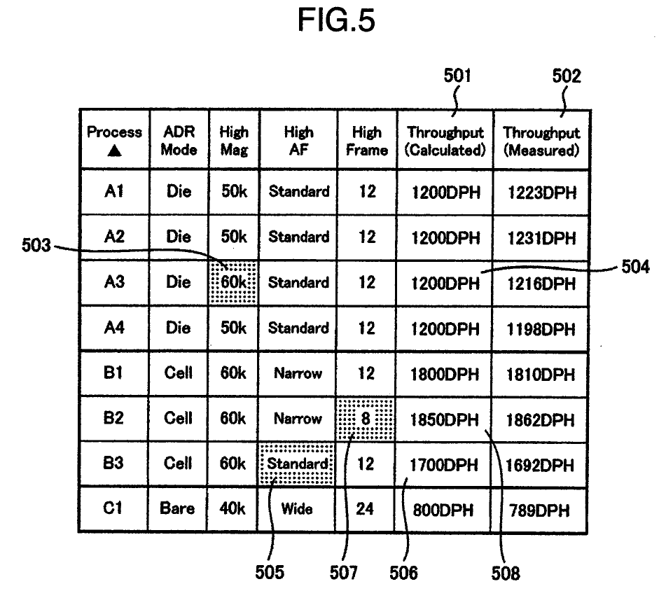

FIG. 5 shows an example in which calculated values (501) of the ADR throughput and values (502) obtained by actual measurements are added to the results of the recipe analysis and displayed. Comparison of A1, A2, A3, and A4, each having a “Process” name starting with A, reveals that only A3 is different in value (503) of “High Mag”. However, the magnification of high-magnification images does not affect the ADR throughput. Consequently, A3 is identical with A1, A2, and A4 in calculated value (504) of throughput. On the other hand, comparison of B1, B2, and B3, each having a “Process” name starting with B, shows that B3 is lower than B1 and B2 in calculated value (506) of throughput, because the setting (505) of “High AF” of B3 is in a mode in which emphasis is placed on the accuracy and thus the processing speed is low, unlike B1 and B2. Furthermore, B2 is higher than B1 and B3 in calculated value (508) of throughput, because the value (507) of “High Frame” of B2 is set to a mode in which emphasis is placed on the throughput rather than the image quality and thus the processing speed is high, unlike B1 and B3. The actually measured value (502) of throughput indicates the result of a measurement of the throughput in a case where ADR (automatic defect review) is carried out using the corresponding recipe in practice. At this time, the result can be either the result of the newest measurement or an average value of the results of plural measurements. Alternatively, both may be displayed. In this way, the throughput is displayed, thus making it possible to quickly check the effects of updating of the recipe. Consequently, optimization of the recipe can be carried out efficiently.

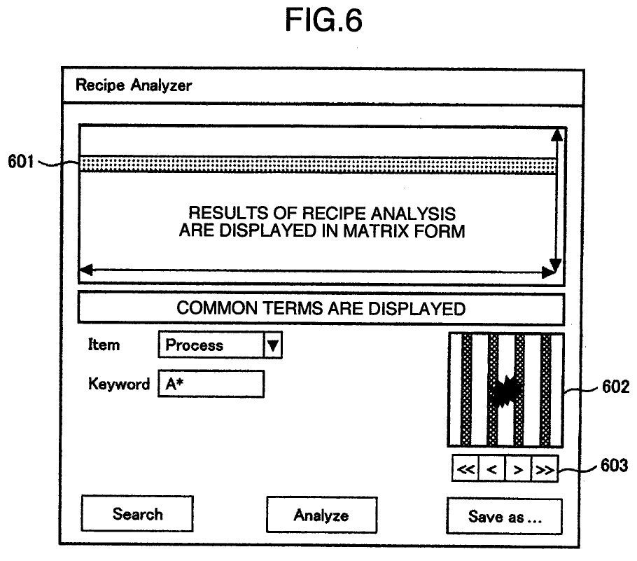

FIG. 6 shows one example of GUI (graphical user interface) in which a list of results of a recipe analysis and an image acquired with a recipe specified from the list are made to correspond to each other and displayed. In this example, an image display portion 602 and image updating buttons 603 are added to the example of GUI of FIG. 4A. An image acquired using the recipe 601 selected from the displayed list indicating the results of a recipe analysis is displayed in the image display portion 602. The displayed image can be updated using the image updating buttons 603. A button indicated by > is used for movement to the next image. A button indicated by < is used for movement to the immediately previous image. A button indicated by >> is used to move the cursor to an image spaced by a given amount, e.g., skipping of 10 successive images. A button indicated by << is used to move the cursor to a previous image spaced by a given amount, e.g., skipping of 10 successive images. In this way, the image is updated. With respect to the form of image display, plural windows may be opened at the same time as long as a recipe selected from a list can be made to correspond to an image acquired with the selected recipe. In this way, the recipe and image can be made to correspond to each other easily. Therefore, regarding a recipe that cannot be judged as to whether it should be subjected to a similarity analysis, for example, only using a device name or a process name, a decision as to whether the recipe should be subjected to the similarity analysis can be easily made by checking the image.

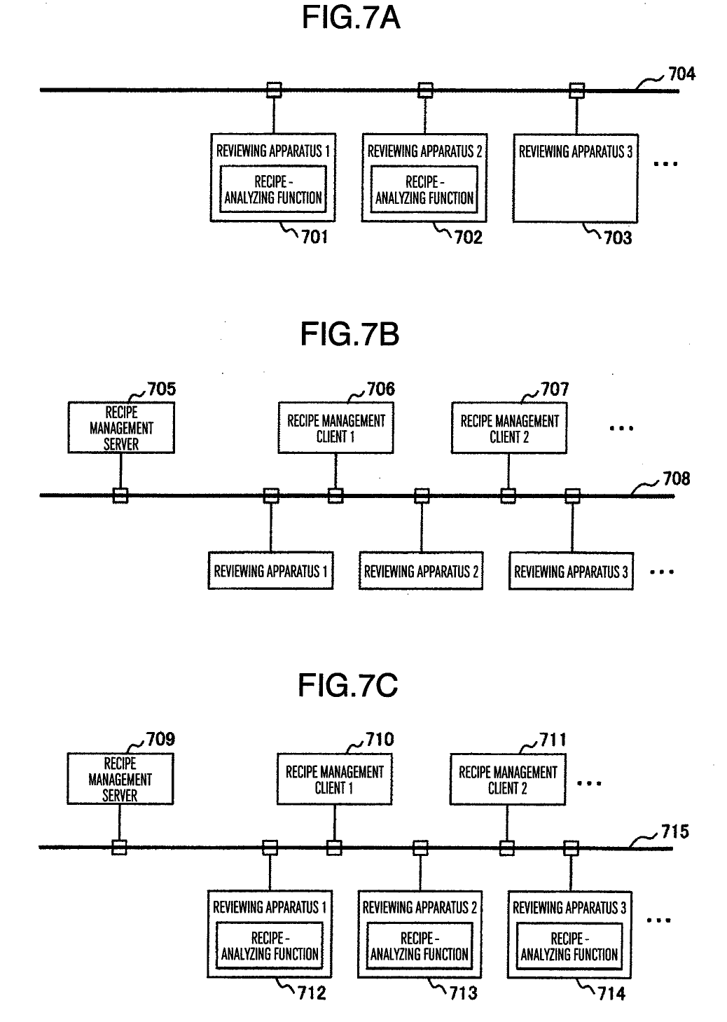

FIGS. 7A-7C show reviewing systems in each of which plural reviewing apparatus are connected via a network, each reviewing apparatus holding recipes to be analyzed by a recipe-analyzing function. In FIG. 7A, plural reviewing apparatus 701, 702, and 703 are connected with a network 704. The network 704 can be a wired network or a wireless network if data can be sent and received by the network. The reviewing apparatus 703 is not fitted with the recipe-analyzing function and so this apparatus cannot perform a recipe analysis. However, the apparatus 703 can analyze recipes held in the reviewing apparatus 703, using the recipe-analyzing function of the reviewing apparatus 701 or 702.

FIG. 7B shows a reviewing system in which plural reviewing apparatus not having a recipe-analyzing function are batch-managed by a recipe management server 705. Created recipes are batch-managed by the recipe management server. If necessary, the recipes can be transferred to the reviewing apparatus and to recipe management clients 706 and 707. Each reviewing apparatus does not have a recipe-analyzing function and, therefore, cannot perform a recipe analysis. However, the recipe analysis can be performed by the recipe management server 705 or by the recipe management client 706 or 707.

FIG. 7C shows a reviewing system having a recipe management server capable of batch-managing recipes. In this system, each reviewing apparatus has a recipe-analyzing function. Therefore, a recipe analysis can be performed from whatever of the recipe management server, recipe management clients, and reviewing apparatus.

The present invention can have the following configurations:

(1) A reviewing apparatus for acquiring review images of a sample, the reviewing apparatus comprising:

a storage device in which plural recipes are stored, the recipes having plural review conditions under which the review images are acquired, the review conditions being registered in the recipes;

an arithmetic unit for extracting common review conditions registered in all of the plural recipes from the first-mentioned review conditions, taking the common review conditions most frequently registered out of the common review conditions as initial review conditions, storing the initial review conditions in the storage device, and creating a new recipe under the initial review conditions; and

a display device for displaying information sent from the arithmetic unit;

wherein the arithmetic unit displays the plural recipes on one display screen of the display device in such a way that the common review conditions are distinguished from other conditions.

(2) A method of setting recipes for a reviewing apparatus for acquiring review images of a sample, said method comprising the steps of:

preparing plural recipes in which plural review conditions under which the review images are acquired are registered;

extracting common review conditions registered in all of the recipes from the recipes;

taking common review conditions most frequently registered out of the first-mentioned common review conditions as initial review conditions;

storing the initial review conditions in memory;

creating a new recipe using the initial review conditions;

causing the new recipe created using the initial review conditions to be displayed on a display device; and

displaying the plural recipes on one display screen of the display device in such a way that the common review conditions are distinguished from other conditions.

It should be further understood by those skilled in the art that although the foregoing description has been made on embodiments of the invention, the invention is not limited thereto and various changes and modifications may be made without departing from the spirit of the invention and the scope of the appended claims.

1. A reviewing apparatus for acquiring review images of a sample, said reviewing apparatus comprising:
a storage device in which (i) plural existing recipes in which review conditions under which the review images are acquired are registered, (ii) plural set items constituting the review conditions set for each of the existing recipes, and (iii) contents of settings stipulating specifications of the individual set items are stored;
a processor for performing a recipe analysis to select recipes to be analyzed from the plural existing recipes and set items and contents of settings corresponding to the recipe to be analyzed, performing a commonality analysis for calculating frequencies at which the contents of settings for the individual recipes are common among the recipes to be analyzed, and displaying a list of results of the recipe analysis on a display device; and
novel recipe creation means which, when the contents of the settings include contents of settings having low commonality frequencies, creates a novel recipe, based on results of the commonality analysis performed by the processor by replacing the contents of settings having the low frequencies by contents of setting having high frequencies to perform initialization.

2. A reviewing apparatus as set forth in claim 1, further comprising means for selecting set items to be displayed on the display device or setting an order in which the items are displayed.

3. A reviewing apparatus as set forth in claim 1, wherein said processor displays results of said commonality analysis on the display device in a form that enables one to discern whether commonalities of the contents of the settings are high or low.

4. A reviewing apparatus as set forth in claim 1, wherein said processor modifies at least one recipe setting, based on a list of results of said recipe analysis displayed on the display device.

5. A reviewing apparatus as set forth in claim 1, wherein said processor computationally estimates throughput based on contents of settings of the recipes obtained by said recipe analysis when acquisition of said review images is done automatically and displays the estimated throughput in the list of the results of the recipe analysis as an element on the display device.

6. A reviewing apparatus as set forth in claim 1, wherein said processor automatically measures throughput based on the contents of the settings of the recipes when said review images are acquired and displays results of the actual measurement in the list of the results of the recipe analysis as an element on the display device.

7. A reviewing apparatus as set forth in claim 1, wherein said processor sets said set items which are at least one of process name, optical conditions, ADR mode, magnification of low-magnification images, autofocus conditions for low-magnification images, number of added frames of low-magnification images, magnification of high-magnification images, autofocus conditions for high-magnification images, and number of added frames of high-magnification images.

8. A reviewing apparatus as set forth in claim 7, wherein said processor displays, in addition to said set items, at least one of comment registered by a user, capture rate in a case where the processor has an ADR function, recipe creator, date of creation, recipe updater, date of updating, and recipe version as an element or elements in the list of the results of the recipe analysis on the display device.

9. A reviewing apparatus as set forth in claim 1, wherein said processor displays images acquired by automatic review based on the contents of the settings of the recipes on the display device in a corresponding manner to the list of the results of the recipe analysis.

10. A method of setting recipes for a reviewing apparatus for acquiring review images of a sample, said method comprising the steps of:
preparing plural existing recipes in which plural review conditions under which the review images are acquired are registered;
preparing plural set items constituting the review conditions set for each of the existing recipes;
preparing contents of settings stipulating specifications of the individual set items;
storing said existing recipes, said plural set items, and said contents of the settings into a storage device;
causing a processor to perform a recipe analysis for selecting recipes to be analyzed from said plural existing recipes, as well as the set items and contents of settings corresponding to the recipes to be analyzed;
displaying a list of results of the recipe analysis on a display device;
performing a commonality analysis using the processor to calculate frequencies at which the set items for the individual recipes are common among the recipes to be analyzed; and
replacing the contents of the settings that are common among the recipes at low frequencies by contents of settings having high frequencies, if such contents of the settings having the low frequencies exist, based on the results of the commonality analysis, taking the contents of the settings as initial settings, and creating a new recipe.

11. A method of setting recipes for a reviewing apparatus as set forth in claim 10, further comprising the step of:
selecting the set items to be displayed on the display device or setting an order in which they are displayed.

12. A method of setting recipes for a reviewing apparatus as set forth in claim 10, further comprising the step of:
displaying the results of said commonality analysis on the display device in a form permitting one to discern whether commonalities of the contents of the settings are high or low.

13. A method of setting recipes for a reviewing apparatus as set forth in claim 10, further comprising the step of:
modifying at least one recipe setting based on the list of the results of said recipe analysis displayed on the display device.

14. A method of setting recipes for a reviewing apparatus as set forth in claim 10, further comprising the steps of:
computationally estimating throughput when said review images are acquired automatically based on the contents of the settings of the recipes obtained from said recipe analysis; and
displaying results of the computational estimation in the list of the results of the recipe analysis as an element or elements.

15. A method of setting recipes for a reviewing apparatus as set forth in claim 10, further comprising the steps of:
actually measuring throughput when said review images are acquired automatically based on the contents of the settings of the recipes; and
displaying results of the measurement in the list of the results of the recipe analysis as an element or elements.

16. A method of setting recipes for a reviewing apparatus as set forth in claim 10, further comprising the step of:
setting at least one of process name, optical conditions, ADR mode, magnification of low-magnification images, autofocus conditions for low-magnification images, number of added frames of low-magnification images, magnification of high-magnification images, autofocus conditions for high-magnification images, and number of added frames of high-magnification images as said set items.

17. A method of setting recipes for a reviewing apparatus as set forth in claim 16, further comprising the step of:
displaying, in addition to said set items, at least one of comment registered by a user, capture rate in a case where there is an ADR function, a recipe creator, date of creation, recipe updater, date of updating, and recipe version as an element or elements in the list of the results of the recipe analysis.

18. A method of setting recipes for a reviewing apparatus as set forth in claim 10, further comprising the step of:
displaying images acquired by automatic review based on the contents of the settings of the recipes on the display device in a corresponding manner to the list of the results of the recipe analysis.

19. A reviewing system having a plurality of reviewing apparatus connected via a network, the reviewing apparatus acquiring review images of a sample, said reviewing system comprising said reviewing apparatus each of which has:
(a) a storage device in which (i) plural existing recipes in which review conditions under which the review images are acquired are registered, (ii) plural set items constituting the review conditions set for each of the existing recipes, and (iii) contents of settings stipulating specifications of the individual set items are stored;
(b) a processor for performing a recipe analysis to select recipes to be analyzed from the plural existing recipes and set items and contents of settings corresponding to the recipe to be analyzed and performing a commonality analysis for calculating frequencies at which the contents of settings for the individual recipes are common among the recipes to be analyzed;
(c) a display device for displaying a list of results of the recipe analysis; and
(d) novel recipe creation means which, when the contents of the settings include contents of setting having low commonality frequencies, creates a novel recipe, based on results of the commonality analysis performed by the processor by replacing contents of settings having low commonality frequencies by contents of settings having high frequencies to perform initialization and storing the created recipe in the storage device;
wherein at least one of recipe analysis means and said plurality of reviewing apparatus has a recipe analysis device; and
wherein said recipe analysis device performs the recipe analysis by referring to the new recipes stored by the novel recipe creations means of the plural reviewing apparatus and to results of said commonality analysis performed by said processor.

20. A reviewing system as set forth in claim 19, further comprising at least one second processor connected to said network and having a recipe-analyzing function,
wherein the second processor refers to the recipes stored in the plural reviewing apparatus and to results of the recipe analysis and carries out a recipe analysis in any one or more of the plural reviewing apparatus.
